(19) United States
(12) Patent Application Publication
(10) Pub. No.: US 2001/0044905 A1
(43) Pub. Date: Nov. 22, 2001

(54) System and method for secure data communications

(75) Inventors: Boris Novak, Ramat Almogi (IL); Regina Novak, Ramat Almogi (IL)

Correspondence Address: Mark Ungerman, Fulbright & Jaworski, LLP, 801 Pennsylvania Avenue, N.W., Washington, DC, 20004, US

(73) Assignee: Recyfer, Inc., Kafar Saba (IL)

(21) Appl. No.: 09/818,635

(22) Filed: Mar. 28, 2001

Related U.S. Application Data
(60) Provisional application No. 60/204,116, filed on May 15, 2000.

(51) Int. Cl. H04L 9/00; H04L 12/22

(52) U.S. Cl. 713/201; 709/203

(57) ABSTRACT

A system and method for secure communications over public networks. The system has a 3-layer hierarchical structure including a system kernel, secure servers and secure clients. Secure clients may communicate via trusted secure servers. Secure servers function according to the system secure operation rules and, in addition, each of them is configured to perform specific activities. System kernel serves the system to support its regular functioning. Any two secure data switching elements, which communicate within the system, have their own ciphering language, periodically substituted by another ciphering language.

### CROSS-REFERENCE TO RELATED APPLICATION

This application claims the benefit of United States Provisional Application, filed May 15, 2000, which is incorporated herein by reference.

### BACKGROUND OF THE INVENTION

1. Field of the Invention

The invention relates generally to secure communication over public networks and, more particularly, to a system and method for providing secure data transfer between network nodes by way of secure data switching.

2. Background of the Invention

Extensive utilization of public networks in all spheres of communication, including applications with extremely sensitive data such as e-business, military, research works and private correspondence, make security and privacy of the communication the primary concern of the public networks' users. Various secure systems and theories address the requirements of secure communication, however, these systems and theories have gaps in the security.

Solutions for secure communication, such as centralized secure systems, do not solve the above mentioned problems, because they do not provide the possibility of secure access to a node outside their own secure sub-network, and thus limit every user to secure communication only within its own private system over public network.

Two well-known security technologies—Virtual Private Network (VPN) and Public Key Infrastructure (PKI). VPN reduces the infrastructure and the communication link costs and allows the creation of secure link between a corporate LAN and a remote user's PC, which increases the connection security.

PKI is an infrastructure intended for secure communication over public networks and used mainly for verifying the authenticity of each party involved in an Internet transaction, which protects against fraud or sabotage. Additionally, PKI provides consumers and retailers protection against the denial of transactions. Use of both technologies is problematic, and it becomes even more so with the increase of Internet utilization.

The article Joel Snyder, “VPNS: Fast, not friendly”, Network World, May 10, 1999 points out that VPN imposes limitations on the user to operate only within the VPN structure, which created the problem of non-interoperability between different private networks. This method denies the user flexibility. For example, the user can not switch between or accesses different private networks.

According to Carl Ellison and Bruce Schneier, “Ten Risks of PKI: What You're not Being Told about Public Key Infrastructure”, Computer Security Journal, Jan. 1, 2000, PKI, has authentication and identification problems.

Another popular electronic communication, e-mail, is not secure enough. When an e-mail is transmitted over the Internet, it travels from the sender to the sender's Internet Service Provider (ISP), via nodes unknown to the sender (other ISP clients) and then to the addressee (via more unknown Internet nodes). Most e-mail is promptly and successfully delivered, without prying eyes viewing the e-mail. However, there are cases, when e-mail messages are intercepted, read, corrupted and falsified. Traditional e-mail cannot be entrusted with sensitive information, such as business plans, invoices, purchase orders, and other financial documents or secret data. For this purpose, businesses continue to rely on the paper-based communications, such as faxes and special deliveries, to transfer these important documents.

Most recently, some e-mail service providers started to utilize the Pretty Good Privacy (PGP) program—a simple and convenient data securing mechanism, which has all the flaws of the PKI.

One more problem of the communication over public network is disclosure of the communicating parties. To conceal the end-to-end connection is sometimes almost as important as the application data security, since many private users and organizations are not ready to expose their connections to anybody except for their own trusted servers.

Additional important and seldom satisfied requirement—fast detecting and isolating forgery cases during secure data transfer. When this capability is supported not only by digital signature, but by the ciphering key utilization policy as well, the fake message not only is discovered, but also the exact communication link is determined.

The main reason of all above deficiencies results from application of incomplete security technologies, developed to solve specific problems' instead of providing comprehensive security solution for all aspects: authentication, authorization, encryption, etc.

### SUMMARY OF THE INVENTION

The invention relates to a scalable security system over public networks, providing real privacy and high-level security to network users and service providers.

An object of the present invention is to provide public network security services by way of a superstructure over the network. The superstructure may be constructed as an open distributed system of secure nodes, which may be interconnected by secure channels. Strong security services may be achieved by transferring data in the network using secure servers that use at every link in the data transfer a different private ciphering language, which may include two sets of ciphering algorithms with corresponding cipher-keys' collection, one set in every link direction.

The open structure of the secure system may be achieved by constructing it in three layers:

secure system authority—the kernel of the secure system—performs the system management and provides assistance to the secure servers;

secure servers—provide security services to the clients of the secure system; in addition, every secure server can be configured to perform specific security functions, required by its owner; new secure servers can be added to the functioning system at any time;

secure clients—those public network nodes which are members of the secure system; like the secure servers, any secure client can be added to the secure system at any time.

Another object of the invention is to increase the strength of the encryption/decryption engine by combining the advantages of symmetric ciphering and asymmetric ciphering. This may be achieved by breaking the secret paths into several (normally two or three) secure links, and utilization of different symmetric algorithms along every path without the need to provide shared keys or public keys in advance to the communicating end-parties. Thus the strength of the secret key algorithms may be combined with the flexibility normally attributed to establishing secure connections under a public key algorithm based system.

Another object of the invention is to intensify the resistance of the symmetric algorithms to external attacks implementing a bidirectional private ciphering language for every pair of secure nodes and by regular online replacement of the ciphering keys. These features provide a unique way of message ciphering for every data transfer.

Another object of the invention is to enhance the privacy of communicating parties by concealing in the message the end-to-end (source client and destination client) addresses. This may be possible, since two clients do not communicate directly. In other words, the source client and the destination client communicate via at least one server.

Another object of the invention is to enhance the privacy even more by secure data transfer via transit secure server, which routes the message further along the secure path without possibility to read the application data.

Another object of the invention is to detect message forgery at a secure link resolution, which is enabled by the private ciphering language utilization policy and the ability to perform authentication process in every communication link.

Another object of the invention concerning secure message failure processing is to reduce the problem of recovery to the need to substitute one private ciphering language only, which may be enabled by disclosing the specific link failure.

Another object of the invention is to support secure multicast and broadcast transmissions in the most effective and flexible way by implementing it in secure servers.

Another object of the invention is to provide data transfer intensified security by executing a data split and further transfer of the split data along different secure routes via secure servers, enabled by the system structure operation.

Another object of the invention is to enable the public network users to freely provide parameters for the data transfer process, which is possible since the secure system may be implemented at the presentation communication layer.

A distributed system which is an embodiment of the invention is hereafter referred to as Distributed Secure Data Switching System, or SDS System.

The architecture of the SDS System may enable it to plug in any type of network.

These and other objects of the present invention will become apparent to those skilled in the art from the following detailed description of the invention and preferred embodiments, the accompanying drawings, and the appended claims.

### BRIEF DESCRIPTION OF THE DRAWINGS

FIG. 1 illustrates an embodiment of the invention for a public network with plugged-in SDS System.

FIG. 1A illustrates a schematic drawing of typical computer utilized in an embodiment of the invention.

FIG. 2 illustrates a schematic drawing of the secure connection between two network nodes that are clients of the SDS System.

FIG. 3 illustrates secure data transfer between two nodes via an SDS Server with services from public servers in public network.

FIG. 4 illustrates secure data transfer between two nodes via two SDS Servers and with services from public servers in public network.

FIG. 5 illustrates secure data transfer between two nodes via two SDS Servers, which are not mutually registrated with each other, that utilize the secure system authority and the public network servers.

FIG. 5A illustrates secure data transfer between two nodes via two SDS Servers, which are not mutually registrated with each other, that communicate by establishing a one-time communications session.

FIG. 6 illustrates the processing of transmitted message in SDS System.

FIG. 7 illustrates the processing of received message in SDS System.

### DESCRIPTION OF THE INVENTION AND THE PREFERRED EMBODIMENTS

The present invention relates to a method of constructing a distributed system, which provides secure services in a public network. In other words, the invention relates to a distributed secure service provider.

In the following detailed description of the preferred embodiments, reference is made to the accompanying drawings which form a part hereof. The detailed description and drawings show specific preferred embodiments in which the invention may be practiced by way of illustration. These embodiments are described in sufficient detail to enable those skilled in the art to practice the invention, and it is to be understood that other embodiments may be utilized and that changes in network configuration may be made without departing from the spirit and scope of the present invention. The following detailed description is, therefore, not to be taken in a limiting sense.

Those, that enjoy the services of said secure service provider may be computers users and sub-networks' nodes connected to the public network, in which the secure service provider may be installed.

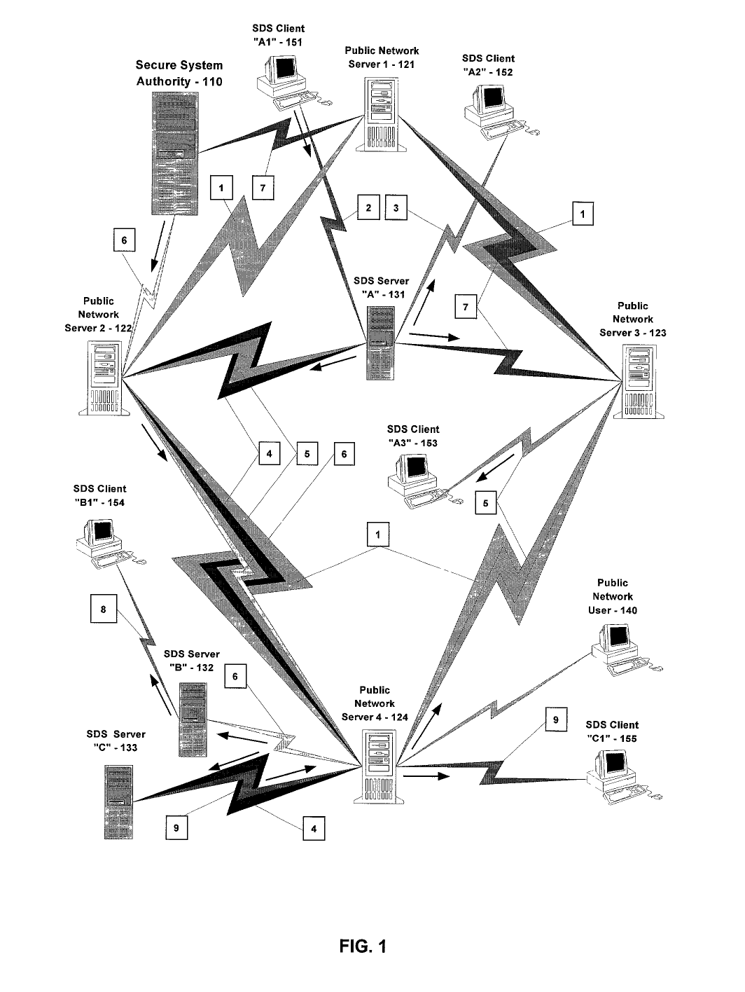

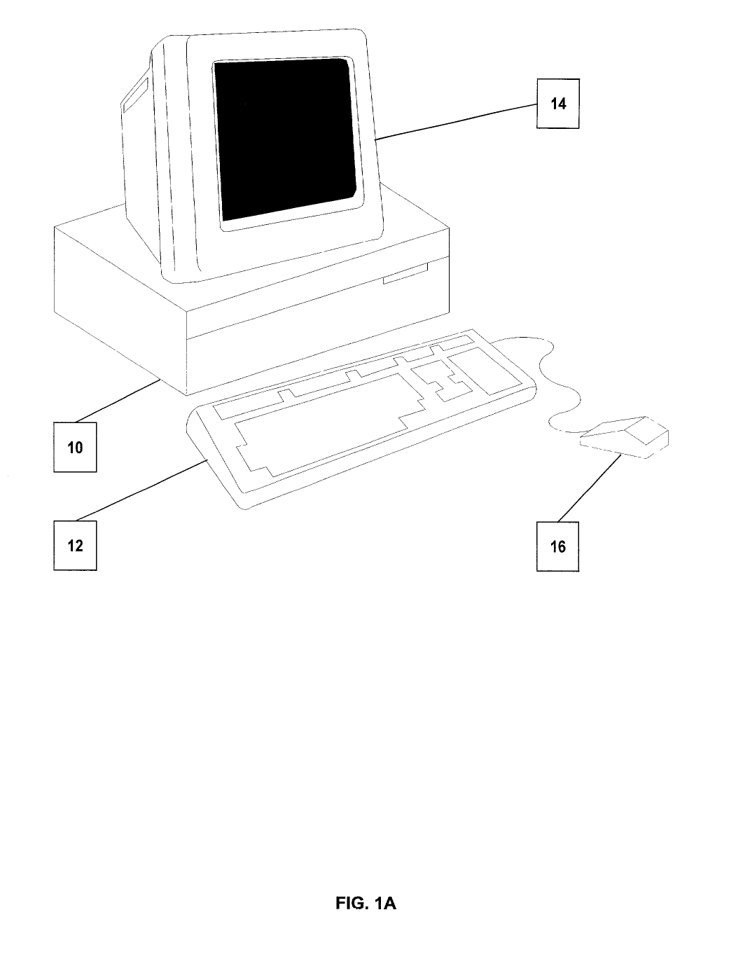

A typical computer on which the present invention may be implemented is shown in FIG. 1A. Computer 10 may run any type of communication application, which allows a computer to access another computer over a communications medium/network. Such communications application could, for example, be a type of Internet browser. The computer 10 may be a workstation, desktop computer, laptop computer, mobile computer, embedded system, wireless device and/or other computer. Suitable communication networks include local area networks, metropolitan area networks, wide area networks, the Internet, or any combination thereof.

Various possible types of communication links may be employed for the connection between the secure servers and the secure clients. For example, the communication link may be a hard wired connection, a telephone connection, a satellite RF, or other wireless connection, an Internet connection, a local area network or wide area network connection, a combination of the preceding, or any other desired type of connection. Different machines can connect using different types of communication links.

In an embodiment of the invention, the method and system may be a superstructure over a communications network, which serves as the communication basis of the secure data switching system.

FIG. 1 shows an overview of a public network using the secure data system (100). The system may be a three-layer superstructure over a public network including a secure system authority (110), secure servers (131, 132, 133) and secure clients (151, 152, 153, 154, 155). The first layer may be a secure system authority, the kernel of the secure data switching system (110), that supports system communication functions by maintaining information regarding the secure servers and assisting in server operations. The secure system authority may be the only constant part of the secure data switching system. In large public networks system authority may be implemented as a distributed sub-system. The second layer may be a number of secure servers (131, 132, 133), that secure communication information and application data for transfer within the system. In addition, the secure server may execute the data transfer control and routing procedures. The secure server may be configured to perform specific user defined security functions. The secure server may have secure connections with the secure system authority, with a number of other secure servers and with a number of secure clients. Finally, the third layer may include secure clients—network nodes, with installed SDS Client functions. The system kernel (110), secure servers (131, 132, 133) and secure clients (151, 152, 153, 154, 155) may be secure elements/nodes of the secure data switching system.

A public network node may become a secure server of the Secure Data Switching System by registering with a secure system authority. During registration, a private ciphering language may be constructed and installed in the corresponding secure server. This private ciphering language may only be used for communication between the secure system authority and the mentioned secure server. The secure system authority maintains a database with information regarding related network nodes (secure servers), which may be updated when a secure server registers with the secure system authority.

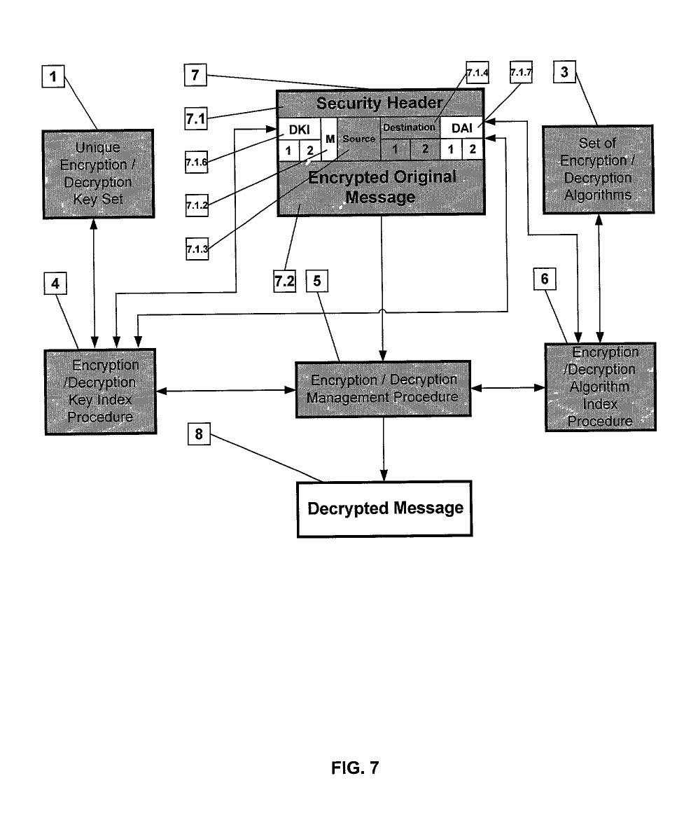

In an embodiment of the invention, each secure server may be registered with a secure system authority. For communicating, a secure system authority may have a different private ciphering language for each secure client. In FIG. 7, for example, data path 7 designates the private ciphering language for the secure system authority and secure server A. The secure system authority will only communicate with secure server A using the private ciphering language of data path 7.

When the secure server is registered with the secure system authority, the secure server may have other functions installed. For example, a procedure for generating private ciphering languages for secure clients, a procedure for secure client registration, a procedure for establishing secure connections with other secure servers and a procedure for secure server functioning during secure communication (i.e., message transfer).

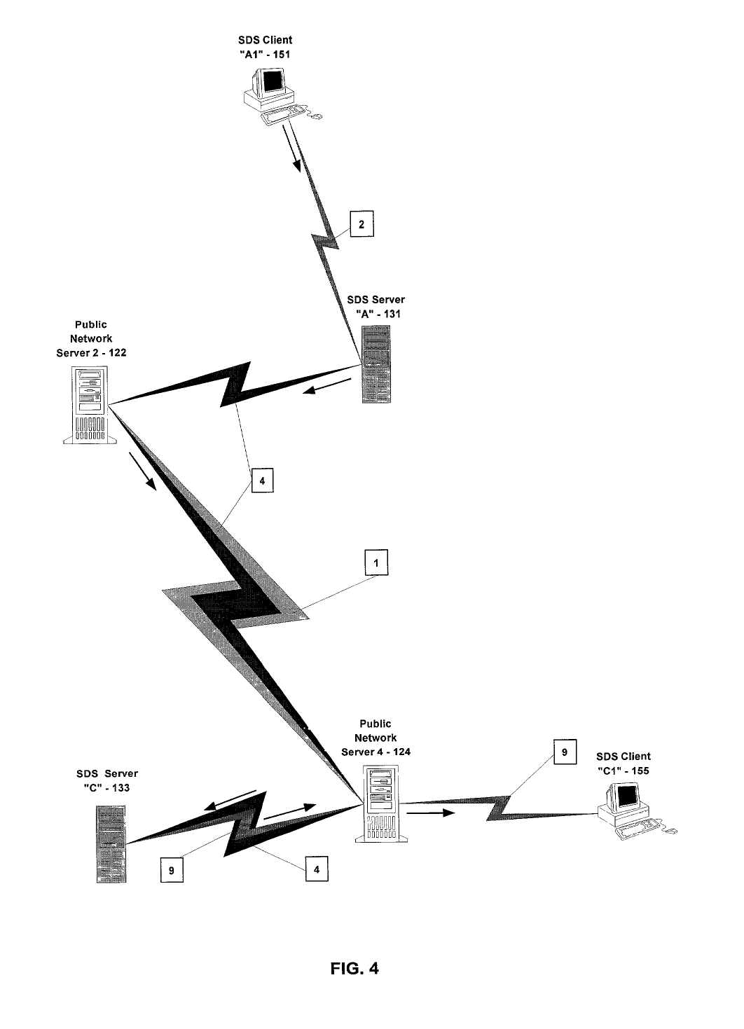

Two secure servers may be mutually registered with the assistance of the secure system authority. Mutual server registration enables secure servers to communicate by a direct connection for secure data transfer. In an embodiment of the invention, secure server A may be registered with the secure server C, as shown in FIG. 4. The private ciphering language used between secure server A and secure server C is designated by data path 4. The server registration procedure may include generating a private ciphering language for two secure servers. Each secure server generates an encryption (output) language set, which may be installed in the other secure server as a decryption (input) set. The private ciphering language may only be used for communications between the two secure servers. Each secure server maintains a database with information regarding related network nodes, which may be updated when the secure servers registers with each other in the secure switching system.

A network user becomes a secure client by registering with at least one secure server and installing secure client functions. During the registration procedure, the secure server generates a private ciphering language for the client. The private ciphering language may be provided to the client by installing a secure client package. The secure server and secure client each maintain a database with information regarding related network nodes, which may be updated when the secure client registers with the secure server.

As mention above, the elements/nodes of the secure switching system may maintain a list of related directly secure data switching elements/nodes and a private ciphering language for each of them. In addition, each element/node has management procedures for a ciphering key index and a ciphering algorithm index, an encryption/decryption management procedure, a procedure for online key set substitution and a package for computer protection against intruders during sensitive operations.

In the present invention, two communicating secure elements/nodes in the system directly exchange messages using a private ciphering language. A private ciphering language may belong to a pair of communicating secure elements/nodes. The private ciphering language may include two ciphering sets, each active in one of the two communication directions (i.e., one ciphering set for transmission and one ciphering set for reception). In other words, a private ciphering language between two secure switching nodes may be installed in the first node as an encryption ciphering language set, and in the second node—as a decryption ciphering language set, while the other set may be installed in the second node—as an encryption set, and in the first node—as an decryption set. Each ciphering set may be a combination of a number of ciphering algorithms and unique collections of cipher-keys. There may be one unique collection of cipher-keys for each ciphering algorithm in each language set. Each ciphering set serves for the message data encryption by the sending node of the communication link and for the data decryption by the receiving node of the communication link.

When a secure node encrypts a message, a current cipher-key may be selected from a cipher-key collection (no key in the collection may be used more than once). For each message, a new (not yet utilized) cipher-key may be selected from the relevant cipher-key collection; the key selection may be performed by the source secure element/node. The selected key index and the ciphering algorithm index may be supplied to the destination secure element/node in the security header of the message.

Every secure element/node accepts with its private ciphering language two sets of ciphering algorithms and corresponding unique collections of cipher-keys, one set for each communication direction. This embodiment of the invention may enable online replacement of the cipher-key collections. A new key collection may be created and delivered to the secure node using a cipher-key of the current key collection. Cipher-key collection replacement may be performed using regular communications before the current key collection is exhausted.

For example, cipher-key collection replacement for use between a secure client and a secure server may be performed by the secure server, which generates and delivers the new key collection to the secure client using a cipher-key of the current key collection. Cipher-key collection replacement for use between a secure server and a secure system authority may be performed by the secure system authority, which generates and delivers the new key collection to the secure server using a cipher-key of the current key collection. Key collection replacement for use between two secure servers may be performed by each server generating and delivering an input key collection to the other secure server. The key collection delivery in each direction may be performed using a yet unused cipher-key of the corresponding key collection. When a key secret of a secure node is revealed (or suspected to be so), the key replacement may be done offline by the SDS System provider using initial registration procedure. Other secure group members are not influenced by said security failure.

During a secure message transfer, a secure server can act as a fully entrusted server, called hereafter Authorized Server, or as an intermediate channel for secure message transfer, called hereafter Transit Server. Authorized Server re-encrypts both secure communication information and the message data from the message source ciphering language to the message destination ciphering language. Transit Server re-encrypts only the source communication information, and is not able to decrypt the message data intended for another secure destination. Utilization of a secure server as an Authorized Server or as a Transit Server for current message transfer is the decision of the message source.

As shown in FIG. 7, when a secure server receives a secure message, the server's Encryption/Decryption Management Procedure Module 5 processes the message secure communication information by extracting a ciphering algorithm from the Set of Encryption/Decryption Algorithms 3 using the algorithm index DAI (7.1.7[1]) and Encryption/Decryption Algorithm Index Procedure 6. A cipher-key may be extracted from the Unique Encryption/Decryption Key Set 1 using the cipher-key index DKI (7.1.6[1])) and Encryption/Decryption Key Index Procedure 4. Once the secure server has decrypted the security header, it may determine the destination client and the message's next secure destination node and also it determines its own role in current data transfer: Authorized Server or Transit Server. In both cases it encrypts the secure communication information according to the next secure destination.

If the secure server is designated as an Authorized Server, it decrypts the message data using ciphering language, specified by the DAI (7.1.7[2]) and DKI (7.1.6[2]) indexes and corresponding procedures. The data may be encrypted using an encryption ciphering set related to the next secure node.

If the next secure node is not related to the Authorized Server (e.g., two secure servers that do not have a mutual private ciphering language), the secure system authority may generate a temporary ciphering language for the Authorized Server to communicate directly with the next authorized server. The temporary ciphering language may only be used for one message transfer. As an alternative solution, the secure Authorized Server may transmit the secure message to the secure system authority, which re-encrypts the message for the next secure server.

When a message is received, a secure server acts as a Transit Server for the first stage of the message processing—re-encrypts the secure communication only. If it appears to be an Authorized Server, it performs also the second stage of message processing—re-encrypts the application data.

Within the secure switching system, only the secure elements/nodes may communicate using the secure data switching protocol. Network routers, which are not secure elements/nodes, take part in secure data transfer as mere communication transits; they cannot read the encrypted header information and application data, and may be transparent to the secure elements/nodes. For example, a public network server may store the secure message until an Authorized Server or a client requests the message.

FIG. 1 shows the different ciphering languages used between elements/nodes. Data path 1 may be not ciphered data transfer in public network. Data path 2 may be the private ciphering language of SDS Server A (131) and SDS Client A1 (151). Data path 3 may be the private ciphering language of Server A (131) and Client A2 (152). Data path 4 may be the private ciphering language of Server A (131) and Server C (133). Data path 5 may be the private ciphering language of Server A (131) and Client A3 (153). Data path 6 may be the private ciphering language of Secure System Authority (110) and Server B (132). Data path 7 may be the private ciphering language of Server A (131) and Secure System Authority (110). Data path 8 may be the private ciphering language of Server B (132) and Client B1 (154). Data path 9 may be the private ciphering language of Server C (133) and Client C1 (155).

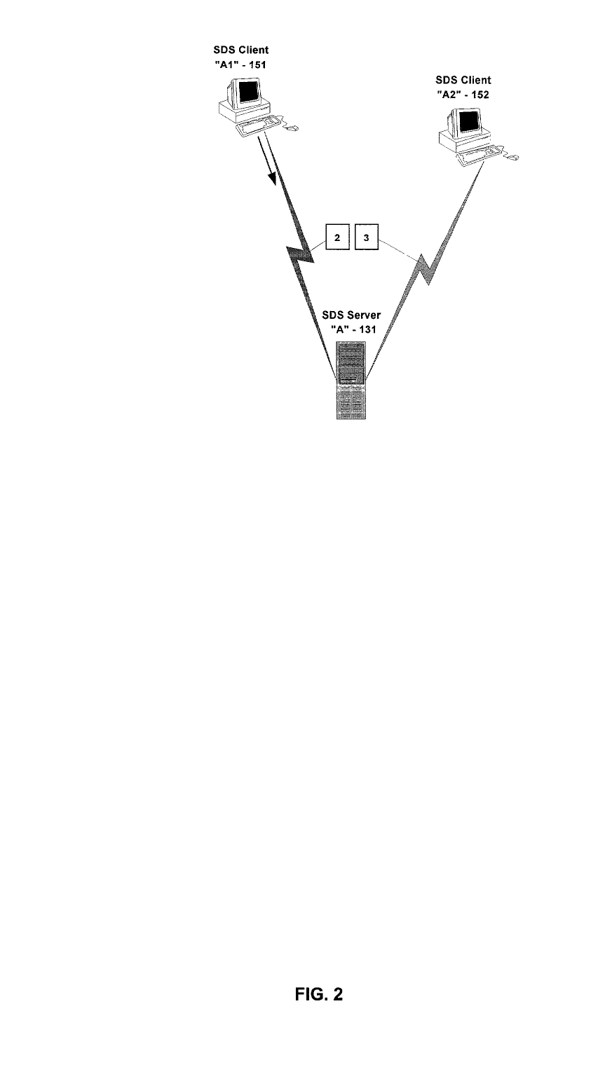

FIGS. 2-5 show various secure data transfer paths of the secure data switching system of FIG. 1.

FIG. 2 shows a schematic drawing of the secure connection between two network nodes—Clients A1 and A2 (151, 152), which may be clients of the secure data switching system and may be both registered users of the same Server A (131). In this example, SDS Client A1 (151) transmits a secure message to SDS Client A2 (152). The message sent by SDS Client A1 may be transmitted using private ciphering language 2. In other words, Client A1 may encrypt the message by using a transmission ciphering set related to Server A. The encrypted message may be received by secure data switching Server A (131) and decrypted using the server's receive ciphering set related to Client A1. The message may be re-encrypted using a transmit ciphering set of Server A that may be related to SDS Client A2. The message may be sent to SDS Client A2 using ciphering language 3. Client A2 may decrypt the message using a receive ciphering set related to the secure data switching Server A.

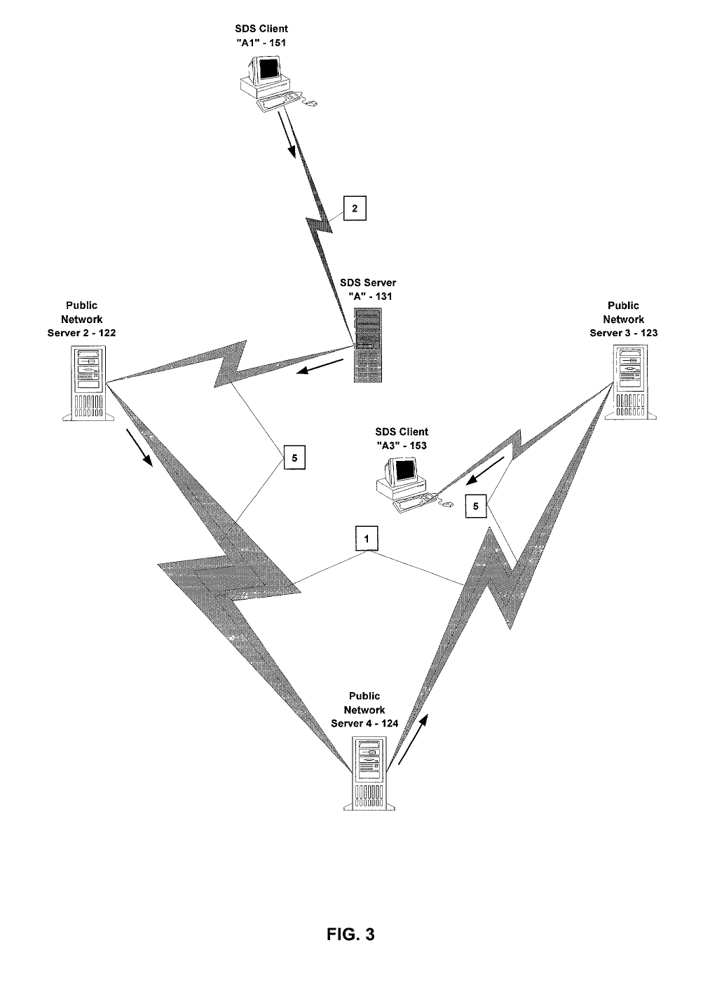

FIG. 3 shows the secure connection between two network Clients A1 and A3 (151, 153), which may be both registered users of the same secure data switching Server A (131). In this example, the network utilizes servers that are not secure data switching servers (122, 124, 123). SDS Client A1 (151) may transmit a secure message to SDS Client A3 (153). The message may be encrypted using private ciphering language 2. In other words, Client A1 may encrypt the message by using a transmission ciphering set related to Server A. The encrypted message may be received by the secure data switching Server A (131) and decrypted using the server's receive ciphering set related to SDS Client A1. The message may be re-encrypted using a transmission ciphering set of ciphering language 5 between Server A and SDS Client A3. Public servers 2, 4, and 3 (in this order) provide the required services without reading the encrypted data including the hidden communication information (for example, store the message until requested by the SDS Client A3), and the message may be transferred to the next node in the network. When SDS Client A3 receives the encrypted message from Public Network Server 3, Client A3 may decrypt the message using a receive ciphering set related to the secure data switching Server A.

FIG. 4 shows the secure connection between two network SDS clients (A1, C1), which are not register users of the same secure data switching server. SDS Client A1 (151) is a registered user of secure data switching Server A (131). SDS Client C1 (155) may be a register user of secure data switching Server C (133). In this example, the network utilizes servers that are not secure data switching servers (122, 124). SDS Client A1 may transmit a secure message to SDS Client C1. The message may be encrypted using private ciphering language 2. In other words, SDS Client A1 may encrypt the message by using a transmission ciphering set related to Server A. The encrypted message may be received by secure data switching Server A (131) and the message may be decrypted using the server's receive ciphering set related to Client A1. The message may be re-encrypted using a transmission ciphering set related to secure data switching Server C. Then, Server A may transmit the message to Public Network Server 2, which forwards the message to Public Network Server 4. Public Network Server 4 sends the message to secure data switching Server C (133). The encrypted message may be received by the secure data switching Server C (133) and decrypted using the server's receive ciphering set related to Server A. The message may be re-encrypted using a transmission ciphering set related to the SDS Client C1 (155). Then, Server C may transmit the message to Public Network Server 4, which forwards the message to SDS Client C1. The encrypted message may be received by SDS Client C1 (155) and decrypted using the client's receive ciphering set related to Server C1.

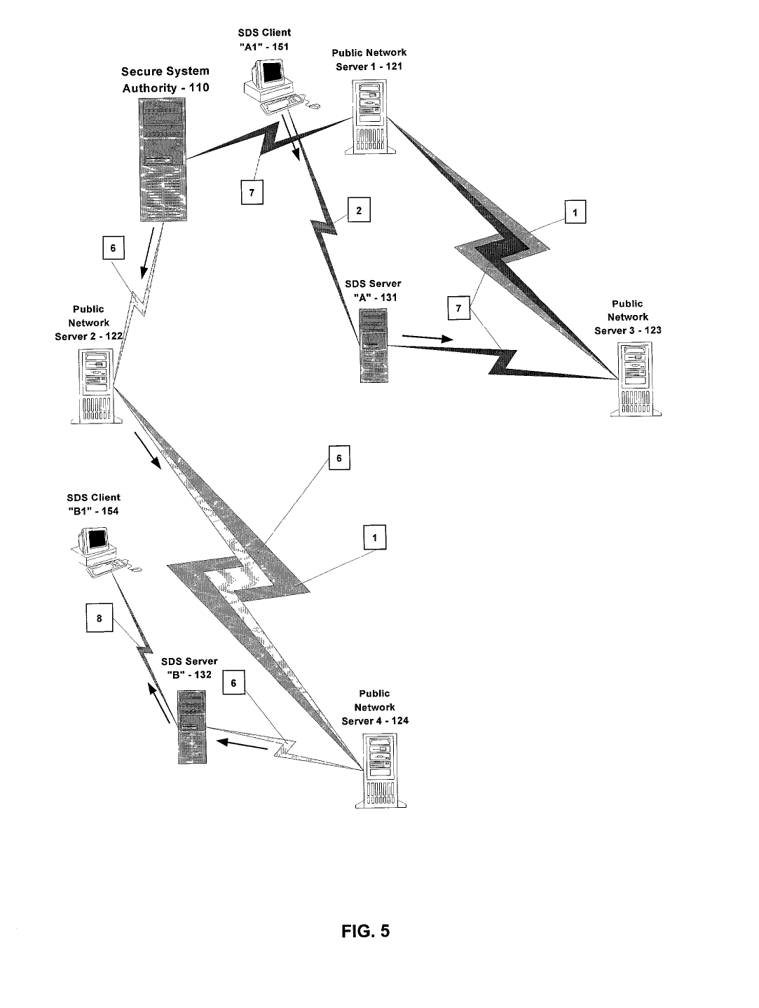

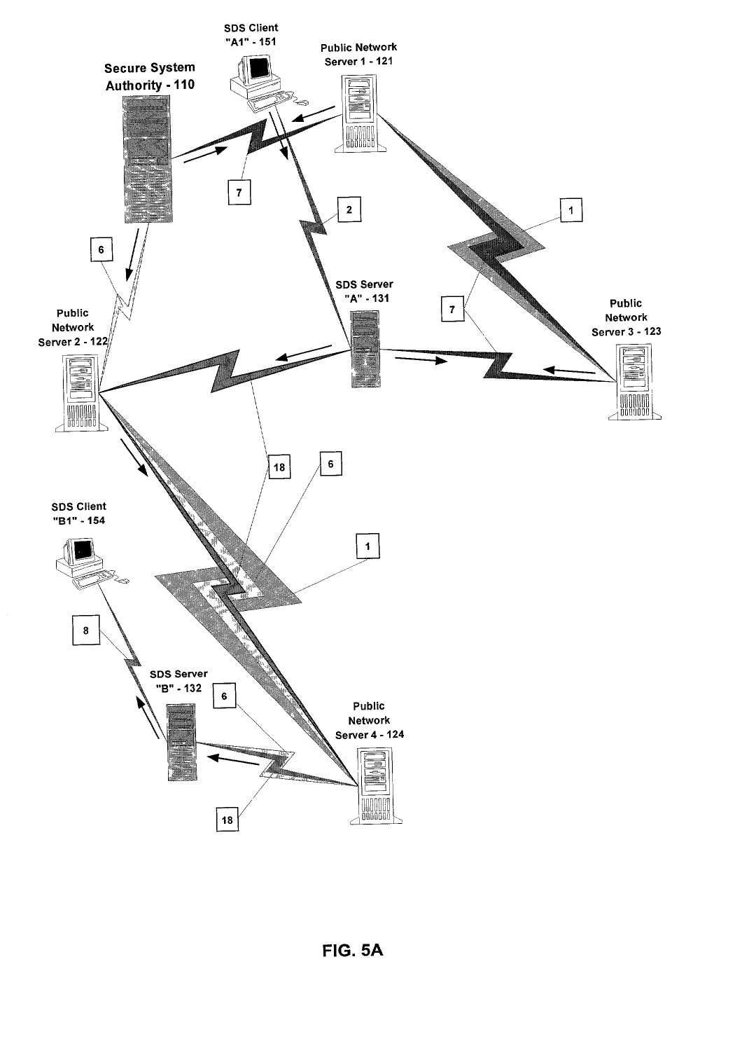

FIG. 5 shows the secure connection between two network SDS Clients (A1, B1), which are not registered users of the same secure data switching server (131, 132 respectively). In this example, the network utilizes servers that are not secure data switching servers (122, 124). SDS Client A1 (151) may transmit a secure message to SDS Client B1 (154). The message may be encrypted using private ciphering language 2. In other words, Client A1 may encrypt the message by using a transmission ciphering set related to Server A. The encrypted message may be received by the secure data switching Server A (131). Server A (131) and Server B (132) are not mutually registered, and Server A chooses to transmit the message to Server B via Secure System Authority (110). The message may be encrypted by Server A for the Secure System Authority using private language 7. Secure system authority receives the message, decrypts it and re-encrypts for server B using private language 6. Server B translates the message from ciphering language 6 into ciphering language 8 and transmits the message to the secure Client B1. SDS Client B1 decrypts the message using ciphering language 8.

FIG. 5A shows the secure connection and the network configuration like in the embodiment presented in FIG. 5 with different solution. SDS Client A1 (151) may transmit a secure message to SDS Client B1 (154) via Server A using private ciphering language 2. Server A (131) and server B (132) are not mutually registered, and server A chooses to establish temporary secure session with server B. It applies to the secure authority, which grants the request and supplies temporary private ciphering language 18 to both servers (131 and 132). Server A transmits the message to server B using private ciphering language 18. After the message is accepted and the secure session completed server B transmits the message to the Client B using ciphering language 8 like in the previous embodiment.

A transmitting element/node may create an encrypted message and security header using an Encryption/Decryption Management Procedure Module.

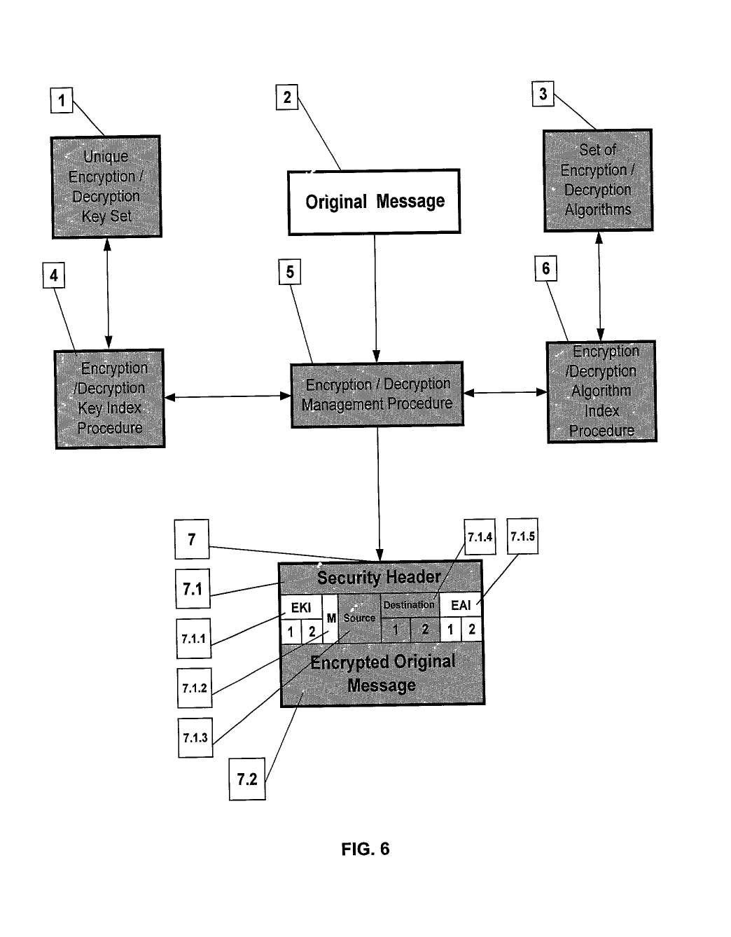

FIG. 6 shows a block diagram of the secure data switching element/node functions for preparing a message for secure transfer in the secure data switching system. An original message 2 may be processed by an Encryption/Decryption Management Procedure Module 5, using Encryption/Decryption Algorithm Index Procedure Module 6 and Encryption/Decryption Key Index Procedure Module 4.

The original message may be encrypted with a private ciphering language that belongs to the pair of communicating secure elements/nodes. A ciphering algorithm may be selected from the Set of Encryption/Decryption Algorithms 3 using the Encryption/Decryption Algorithm Index Procedure Module 6. In addition, an Encryption/Decryption Key Index Procedure Module 4 may be used to extract a cipher-key from the Unique Encryption/Decryption Key Set 1. The selected algorithm and key may be used to encrypt message 2. Same process of selecting encryption/decryption algorithm and ciphering key may be used in order to encrypt the secured information—source (7.1.3) and destination (7.1.4)—of the security header (7.1).

Encryption/Decryption Management Procedure Module 5 may set the algorithm index in both EAI (7.1.5(1)), for original message, and EAI (7.1.5(2)), for the security header. EAI (7.1.5(1)) and EAI (7.1.5(2)) are the same when the same algorithm is used for the original message and the security header. In addition, the cipher-key index may be set in both EKI (7.1.1(1)), for original message, and EKI (7.1.1(2)), for security header. EKI [7.1.1(1)] and EKI [7.1.1(2)] are the same when the same algorithm and the same key are used for the original message and the security header. The algorithm index and the cipher-key index are transmitted in plain text (i.e., not encrypted).

In addition, the transmitting/source client and associated secure server addresses are set in the Source field 7.1.3 and the receiving/destination client and associated secure server addresses are set in the Destination field 7.1.4(1). In addition, a transit server address may be set in the Destination field 7.1.4(2). The source and destination addresses may be encrypted by the selected encryption algorithm and cipher-key. An additional field may be provided to identify the transmission mode 7.1.2. For example, the transmission mode field may have a unicast code, broadcast code, or multicast group number. The transmission mode may be transmitted in plain text (i.e., not encrypted).

A transmitting client may be registered with a secure data switching server, which may receive the client's encrypted message. Using the algorithm index from the security header, the ciphering algorithm may be extracted from the Set of Encryption/Decryption Algorithms by the Encryption/Decryption Algorithm Index Procedure. The Encryption/Decryption Key Index Procedure may extract the transmitting cipher-key from the Unique Encryption/Decryption Key Set using the cipher-key index set in the security header.

FIG. 7 shows the secure data switching element/node functioning as a message recipient. When a message is received by a recipient element/node, the message may be processed by Encryption/Decryption Management Procedure Module 5. Ciphering algorithms may be extracted from the Set of Encryption/Decryption Algorithms 3 using the algorithm index DAI (7.1.7(1)) and DAI (7.1.7(2)) from the security header by means of Encryption/Decryption Algorithm Index Procedure 6. A cipher-key may be extracted from the Unique Encryption/Decryption Key Set 1 using the cipher-key index DKI (7.1.6(1)) and DKI (7.1.6(2)) from the security header by means of Encryption/Decryption Key Index Procedure 4. The recipient element/node may use the ciphering algorithms and cipher-keys to decrypt the message secure information and data.

In an embodiment of the invention, the message can be a secure data switching multicast/broadcast message. The source secure client informs the related secure data switching server, that the current message must be transmitted by multicast/broadcast. The secure data switching server implements the function for all related secure clients. In addition, the secure data switching server passes the message to other secure data switching servers to accomplish the transmission tasks for other secure clients.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

1. A method of establishing a secure distributed system over a public network wherein the system is a superstructure over the network, having a three-layer hierarchic architecture comprising:
a first layer having a secure system authority, which is a constant part in the secure system;
a second layer having a plurality of secure servers;
a third layer having a plurality of secure clients, which are user nodes with installed secure system client services;
wherein each secure server and each secure client may be incorporated into the system at any time;
wherein the minimal number of secure clients in system is two and the minimal number of secure servers is one;
wherein said secure servers, said secure clients and said secure system authority are secure system nodes and provide a continuous secure sub-network over a public network;
wherein any two secure system nodes, communicating via direct secure link within the system, use a private ciphering language for encrypting and decrypting secure message;
wherein each private ciphering language consists of two ciphering sets each comprising a number (at least one) of ciphering algorithms and a collection of cipher-keys for every algorithm;
wherein every ciphering set is used in one known direction of the secure link: one ciphering set is used for encryption by the first link node and for decryption by the second link node, and another ciphering set (in opposite direction) is used for encryption by the second link node and for decryption by the first link node;
wherein a secure node registration with another secure node means that both nodes establish their private ciphering language for encrypting and decrypting a secure message transmitted between said secure nodes;
wherein every secure client can reach directly any secure server with which it is registered;
wherein every secure client can reach any other secure client via the mentioned above secure server(s);
wherein every secure server can reach another secure server directly within the system, or via other secure server(s), or via the secure system authority;
wherein every secure server is registered with the secure system authority;
wherein each secure client is registered with at least one secure server;
wherein two secure servers can be registered with one another;
wherein there is no other type of registration except for the mentioned above registration types;
wherein every secure message in addition to communication information according to the utilized communication protocol, contains specific secure communication information;
wherein the secure servers perform routing functions for a secure message as specified in the secure communication information;
wherein the secure system authority assists a secure server in determining a secure communication path, when required.

2. The method of establishing a secure distributed system of claim 1,
wherein any two secure servers, which do not have mutual ciphering language, can perform secure data transfer:
either via the secure system authority,
or using a one-time direct secure link with one another after secure connection is established between the secure servers by means of secure system authority.

3. The method of establishing a secure distributed system of claim 1,
wherein each cipher-key collection is unique—constructed specially for the corresponding algorithm in current set;
wherein no cipher-key in said cipher-key collection is used more than once.

4. The method of establishing a secure distributed system of claim 3,
wherein after all keys in a cipher-key collection are used it is replaced by another unique cipher-key collection;
wherein the key collection replacement can be performed either via the network using current cipher-key collection, or by the cipher-key collection manual install.

5. The method of establishing a secure distributed system of claim 3, wherein the message source node supplies to the message destination node corresponding index of the cipher-key in the cipher-key collection for data decryption.

6. The method of establishing a secure distributed system of claim 1, wherein secure multicast and broadcast transmissions are implemented by secure server(s) for corresponding secure clients.

7. The method of establishing a secure distributed system of claim 1, wherein the end-to-end secure communication information and the application data are always hidden (ciphered).

8. The method of establishing a secure distributed system of claim 7, wherein the application data and the secure communication information can be encrypted differently.

9. The method of establishing a secure distributed system of claim 8, wherein any secure server can act during secure message transfer either as fully entrusted secure server—Authorized Server, or as a mere secure router in secure system—Transit Server, according to the message requirements.

10. The method of establishing a secure distributed system of claim 1,
wherein any message can be split into sub-messages;
wherein each sub-message is ciphered differently and transmitted as an independent message via different secure server to a destination, where the sub-messages will be assembled into a complete message;
wherein message split can be done either by the message source secure client or by the secure server, appointed by the secure client;
wherein message assembling can be done either by the message destination secure client or by the secure server, appointed by the secure client.

11. The method of establishing a secure distributed system of claim 4,
wherein any two secure servers, which are not registered with one another, can perform secure data transfer:
either via the secure system authority,
or using a one-time direct secure link with another secure server after secure connection is established by means of secure system authority.

12. The method of establishing a secure distributed system of claim 11, wherein the message source node supplies to the message destination node corresponding index of the cipher-key in the cipher-key collection for data decryption.

13. The method of establishing a secure distributed system of claim 12, wherein secure multicast and broadcast transmissions are implemented by secure server(s) for corresponding secure clients.

14. The method of establishing a secure distributed system of claim 13, wherein the end-to-end secure communication information and the application data are always hidden (ciphered).

15. The method of establishing a secure distributed system of claim 14, wherein the application data and the hidden communication information can be encrypted differently.

16. The method of establishing a secure distributed system of claim 15, wherein any secure server can act during secure message transfer either as fully entrusted secure server—Authorized Server, or as a mere secure router in secure system—Transit Server, according to the message requirements.

17. The method of establishing a secure distributed system of claim 16,
wherein any message can be split into sub-messages;
wherein each sub-message is ciphered differently and transmitted as an independent message via different secure server to a destination, where the sub-messages will be assembled into a complete message;
wherein message split can be done either by the message source secure client or by the secure server, appointed by the secure client;
wherein message assembling can be done either by the message destination secure client or by the secure server, appointed by the secure client.
